(19) United States
(12) Patent Application Publication
(10) Pub. No.: US 2009/0256112 A1
(43) Pub. Date: Oct. 15, 2009

(54) Composite material of boron carbide . silicon carbide. silicon

(75) Inventors: Shogo Shimada, Fukuoka-ken (JP); Akio Matsumoto, Fukuoka-ken (JP); Masami Ando, Fukuoka-ken (JP)

Correspondence Address: CARRIER BLACKMAN AND ASSOCIATES, 43440 WEST TEN MILE ROAD, EATON CENTER, NOVI, MI, 48375, US

(73) Assignee: Toto Ltd., Kitakyushu-shi (JP)

(21) Appl. No.: 12/384,480

(22) Filed: Apr. 3, 2009

Related U.S. Application Data
(60) Provisional application No. 61/055,467, filed on May 23, 2008.

(30) Foreign Application Priority Data
Apr. 4, 2008 (JP) 2008-097984
Apr. 4, 2008 (JP) 2008-097997
Jan. 27, 2009 (JP) 2009-015243
Feb. 3, 2009 (JP) 2009-022538

(51) Int. Cl. C09K 3/00; B29C 67/04

(52) U.S. Cl. 252/182.32; 264/682

(57) ABSTRACT

A composite material according the invention includes boron carbide, silicon carbide, and silicon as main components, wherein an average grain diameter of boron carbide grains of the composite material is 10 μm or more and 30 μm or less.

### CROSS-REFERENCE TO RELATED APPLICATIONS

This application is based upon and claims the benefit of priorities from the prior Japanese Patent Application No. 2008-097984, filed on Apr. 4, 2008, the prior Japanese Patent Application No. 2008-097997, filed on Apr. 4, 2008, the prior Japanese Patent Application No. 2009-015243, filed on Jan. 27, 2009, and the prior Japanese Patent Application No. 2009-022538, filed on Feb. 3, 2009; the entire contents of which are incorporated herein by reference.

### BACKGROUND OF THE INVENTION

1. Field of the Invention

Embodiments of this invention generally relate to a composite material having boron carbide, silicon carbide, and silicon as main components, and particularly relate to the composite material of boron carbide.silicon carbide.silicon that has high strength and high specific rigidity and that is excellent in grindability and whose weight can be saved as a structural material.

### DESCRIPTION OF THE RELATED ART

In recent years, for a member composing a moving stage or the like used for an industrial machine such as semiconductor manufacturing equipment or the like, there is requirement of light weight and high rigidity and wall-thinning and weight-saving of the structural members, and high strength has been required.

Its detailed examples include, a three-dimension-measuring device and a linearity-measuring device which are devices with movable body requiring positioning functions of high accuracy, and an exposure apparatus for forming a pattern on a planar body. In particular, the exposure apparatus to manufacture a semiconductor wafer or a liquid crystal panel or the like has been required to have the positioning function of further higher accuracy satisfying the requirement of miniaturization of the pattern in recent years, and it has also been required to improve its through-put by moving at high speed a movable body such as a static pressure fluid bearing device on which a work to be exposed or a reticle is mounted, for economically transcribing a pattern.

However, for satisfying such requirements as described above, it is necessary to thin the walls and save the weights of the stage structural members and to enhance the rigidity to reduce the fictitious force of the stage structural members and thereby to enhance damping property. Moreover, if wall-thinning is possible, freedom degree of the stage design can be increased.

As the structural members requiring such characteristics, conventionally, metal raw materials such as iron and steel have been used. However, recently, alumina ceramics with higher specific rigidity than those of metal raw materials has been used. However, in the case that further higher rigidity is required, it is necessary to use not oxide ceramics such as alumina but non-oxide ceramics. And among them, a boron-carbide-based material having the maximum specific rigidity as an industrial material and also having high bending strength is being expected.

As the boron-carbide-based material, the highest specific rigidity is expected in an approximately pure boron carbide sintered body, but boron carbide is known as a material difficult to be sintered. Accordingly, a conventional boron carbide sintered body has been manufactured by hot pressing. However, in the hot pressing sintering method, it is difficult to manufacture a product with large size and complex shape, and moreover, cost of the hot pressing apparatus for providing high temperature and high pressure or graphite mold is large and therefore the method cannot be a method for realistically manufacturing the structural members.

For solving this problem, a technique of slip casting and pressureless sintering of boron carbide has been disclosed (see, for example, Patent Document 1, Patent Document 2, Patent Document 3, Patent Document 4, Patent Document 5, Patent Document 6). However, in this method, because the sintered body has difficult grindability, there are problems that grinding cost is larger for application requiring high accuracy of size such as semiconductor and liquid crystal manufacturing apparatuses, and that sintering cost is larger because the pressureless sintering temperature is 2200° C. or more, which is considerably high.

Accordingly, there has been disclosed a material in which the boron carbide is not sintered but a boron carbide powder is dispersed as a filler in a metal matrix phase (see, for example, Patent Document 7). In this material, boron carbide is dispersed in aluminum. However, because wettability of boron carbide with aluminum is bad, it is manufactured by hot pressing the mixture of boron carbide and aluminum, and in hot pressing, a product with large size and complex shape cannot be produced and the manufacturing cost is large, and therefore, the method cannot be a method for realistically manufacturing the structural members.

Accordingly, there have been disclosed composite materials each in which silicon whose wettability with boron carbide is relatively excellent is used as a metal matrix and the melted silicon is impregnated into the boron carbide molded body (see, for example, Patent Document 8, Patent Document 9, Patent Document 10). Among them, there is an example including a raw material that can be a small amount of carbon source as the primary material. However, in this method, because boron carbide is highly filled in the composite material although silicon is impregnated, the difficult grindability is not changed although the grindability is improved slightly more than that of the boron carbide. Moreover, because the boron carbide grains include a grain having a grain diameter of 100 μm or more, the grain becomes the origin of break and lowering of bending strength is feared.

Moreover, there have been disclosed composite materials each in which silicon carbide in addition to boron carbide is contained as a raw material of the molded body, and melted silicon is impregnated into the molded body (see, for example, Patent Document 11). Among them, there is an example including a raw material that can be a small amount of carbon source as the primary material. However, in this method, all the same, because boron carbide and silicon carbide are highly filled in the composite material, the difficult grindability is not changed although the grindability is improved slightly more than that of the boron carbide. Moreover, because the boron carbide grains include a grain having a grain diameter of 100 μm or more, the grain becomes the origin of break and lowering of bending strength is feared.

Patent Document: International publication WO 01/72659A1 pamphlet (Page 15-16)

Patent Document: JP-A 2001-342069 (Kokai) (Page 3-4)

Patent Document: JP-A 2002-160975 (Kokai) (Page 4-6)

Patent Document: JP-A 2002-167278 (Kokai) (Page 4-6)

Patent Document: JP-A 2003-109892 (Kokai) (Page 3-5)

Patent Document: JP-A 2003-201178 (Kokai) (Page 4-9)

Patent Document: U.S. Pat. No. 4,104,062 specification (col 2-5)

Patent Document: U.S. Pat. No. 3,725,015 specification (col 2-6)

Patent Document: U.S. Pat. No. 3,796,564 specification (col 2-13)

Patent Document: U.S. Pat. No. 3,857,744 specification (col 1-3)

Patent Document: JP-A 2007-51384 (kohyo) specification (page 20-22)

### SUMMARY OF THE INVENTION

According to an aspect of the invention, there is provided a composite material including boron carbide, silicon carbide, and silicon as main components, an average grain diameter of boron carbide grains of the composite material being 10 μm or more and 30 μm or less.

### BRIEF DESCRIPTION OF THE DRAWINGS

[FIG. 1]

FIG. 1 is a view showing an optical microscopic image of a reaction sintered body in one embodiment of the invention and a comparative example.

[FIG. 2]

FIG. 2 is the result of a linear analysis of boron carbide grains in one embodiment of the invention by EDX (energy dispersive X-ray fluorescence analyzer).

### DETAILED DESCRIPTION OF THE INVENTION

An embodiment of the invention is a composite material including boron carbide, silicon carbide, and silicon as main components, an average grain diameter of boron carbide grains of the composite material being 10 μm or more and 30 μm or less.

According to this composite material, high strength, high specific rigidity, excellent grindability, and weight saving as a structural material can be obtained.

Another embodiment of the invention is the composite material, wherein the maximum grain diameter of the boron carbide grains is less than 100 μm.

Another embodiment of the invention is the composite material, wherein the maximum grain diameter of the boron carbide grains is less than 65 μm.

Moreover, another embodiment of the invention is the composite material, wherein an average of three-point bending strength of the composite material is 350 MPa or more.

Moreover, another embodiment of the invention is a composite material including boron carbide, silicon carbide, and silicon as main components, silicon being included in grains of the boron carbide.

Hereinafter, description of phrases used in this specification will be performed.

(Specific Rigidity)

Specific rigidity is a value of Young's modulus divided by specific gravity, and the specific gravity is a density ratio with respect to water and therefore does not have a unit, and therefore, the unit of the specific rigidity is the same as the unit of Young's modulus. Young's modulus is measured by a resonance method, and the specific gravity is measured by Archimedes' method.

(Average Grain Diameter)

The average grain diameter of grains in the composite material is an average value of the long axes of the grain diameters when a cut surface of the composite material is lapped and 20 or more views each having a size of 0.01 mm² or more is observed by an electron microscope and 200 or more grains are measured.

(Maximum Grain Diameter)

The maximum grain diameter of grains in the composite material is the maximum value of the long axes of the grain diameters when a cut surface of the composite material is lapped and 20 or more views each having a size of 0.01 mm² or more is observed by an electron microscope and 200 or more grains are measured.

(F3)

This means a filling ratio of the solid content of the molded body in the process of manufacturing a composite material according to the invention and is measured by Archimedes' method.

(F3′)

This means a ratio that the vaporizing content part is excluded from the filling ratio of the solid content of the molded body in the process of manufacturing the composite material according to the invention, and the part of the vaporizing content part is calculated from the raw material recipe.

(EDX)

For EDX (energy dispersive X-ray fluorescence analyzer), EMAX7000 manufactured by Horiba, Ltd. was used. Boron carbide grains in the images obtained by SEM (electron microscope) were scanned linearly at 10-20 times and thereby the composition analysis was performed. The scan of one time takes 10s, and the analyzed line width was 0.5 μm. Moreover, the acceleration voltage was set to 15 kV.

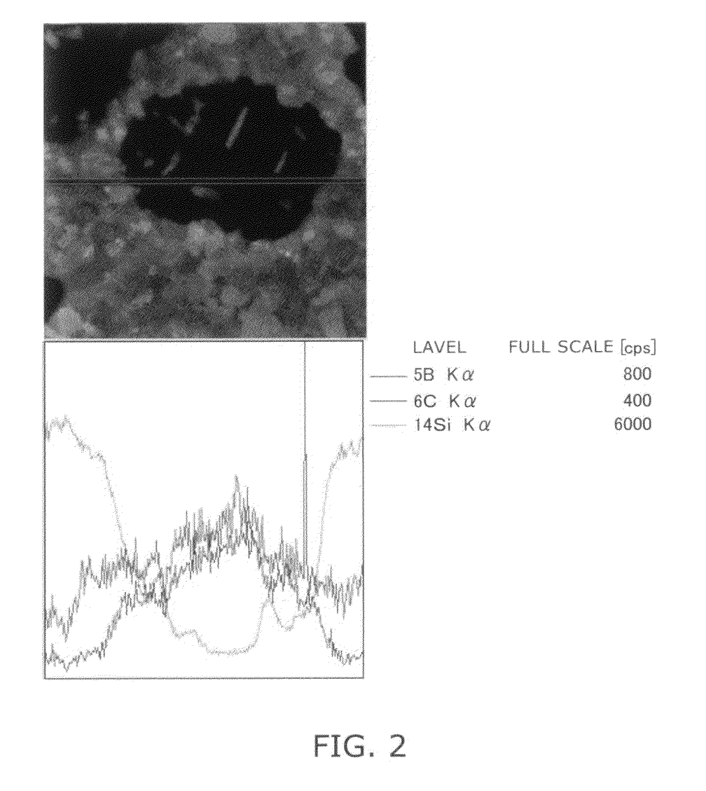

A layer containing silicon is defined as a part in which silicon intensity of the linear analysis graph of FIG. 2 is more than ½ of the sum of the silicon intensity in the boron carbide grain surface and the lowest intensity in the vicinity of the center in the boron carbide grain, and the thickness of the layer is defined as the depth from the surface of the boron carbide grain.

The composite material in one embodiment of the invention has a structure in which silicon is filled in the gap of the grain having boron carbide and silicon carbide as main components. The boron carbide of this composite material is added as a main component of the raw material as a boron carbide powder from the molding step. Moreover, the silicon carbide of this composite material is composed of silicon carbide added as a silicon carbide powder which is a main component of the raw materials from the molding step (hereinafter, referred to as the initial injected silicon carbide), and silicon carbide generated by reaction between the carbon source in the molded body and silicon (hereinafter, referred to as reaction generated silicon carbide).

The method for manufacturing a composite material in one embodiment of the invention includes a reaction sintering step of impregnating molten silicon into a molded body having boron carbide, initial injected silicon carbide, and a carbon source as main components to react the carbon source with the silicon to generate the reaction generated silicon carbide, and impregnating the silicon into the gap among the boron carbide, the initial injected silicon carbide, and the reaction generated silicon carbide.

Moreover, the composite material in one embodiment of the invention is characterized in that the average grain diameter of the boron carbide grains is 10 μm or more and 30 μm or less and preferably the maximum grain diameter of the boron carbide grains is less than 100 μm and further preferably the maximum diameter of the boron carbide grains is less than 65 μm. By adopting such a structure, high bending strength, high specific rigidity, and easy grindability can be obtained.

The maximum grain diameter of the boron carbide grains being less than 100 μm is that grains of 100 μm or more is not substantially included, and grains of 100 μm or more being not substantially included means that as a result of observing the electron microscopic images by the above method, the existence probability of grains of 100 μm or more is one or less in 0.1 mm². The case that the maximum grain diameter is less than 65 μm is the same.

It is preferable that an average of three-point bending strength of the composite material in one embodiment of the invention is 350 MPa or more, and further preferably, 400 GPa or more. In a thin-wall structural body or a process of manufacturing the structural body, if the bending strength is less than 350 MPa, the structural body can be damaged.

Moreover, it is preferable that a specific rigidity of the composite material in one embodiment of the invention is 100 GPa or more, and further preferably, 130 GPa or more. If the specific rigidity is less than 100 GPa, influence of bending of the structural body or the like becomes large and required accuracy cannot be obtained.

Moreover, the composite material in one embodiment of the invention has boron carbide, silicon carbide, and silicon as main components, and is characterized in that silicon is included in the boron carbide grains. Because silicon is included in the boron carbide grains, high specific rigidity and easy grindability can be obtained.

The structural ratios of boron carbide, silicon carbide, and silicon of the composite material in one embodiment of the invention include X parts by volume of boron carbide, Y parts by volume of silicon carbide, and Z parts by volume of silicon as main components, in which the entirety of the composite material is 100 parts, and it is preferable that 10<X<60, 20<Y<70, and 5<Z<30 are satisfied. If the amount of the boron carbide is 10 or less parts by volume, the composite material cannot obtain the sufficient specific rigidity, and if 60 or more parts by volume, grindability of the composite material lowers. Moreover, when the grindability is emphasized, 10<X<50 is further preferable. Moreover, if the amount of the silicon carbide is 20 or less parts by volume, the composite material cannot obtain the sufficient specific rigidity, and if 70 or more parts by volume, grindability of the composite material lowers. Moreover, when the specific rigidity is emphasized, 30<Y<70 is further preferable, and when the grindability is emphasized, 20<Y<65 is further preferable. Moreover, in the composite material having a silicon amount of 5 or less parts by volume, a disadvantage that cracks are generated in the reaction sintering step or that void in which silicon is not impregnated is generated is easily caused, and if 30 or more parts by volume, the specific rigidity of the composite material lowers. In products to be manufactured particularly carefully not to generate a crack such as products with thick walls and large sizes, 10<Z<30 is further preferable.

Accordingly, the composite material in one embodiment of the invention is suitably applied to products requiring high bending strength and high specific rigidity as the structural material.

Hereinafter, detail of materials and processes in one embodiment of the invention will be explained.

In the composite material having boron carbide and silicon carbide and silicon as main components in one embodiment of the invention, the average grain diameter of the boron carbide grains of the composite material is 10 μm or more and 30 μm or less. Moreover, it is preferable that the maximum grain diameter of the boron carbide grains is less than 100 μm, and further preferably less than 65 μm. The average grain diameter of a raw material is measured by laser diffraction. The average grain diameter indicates the average volume diameter. If the average grain diameter of the boron carbide grains is less than 10 μm, cracks or defects such as formation of linear separated silicon phase are caused in the sintered body because reaction between the boron carbide and the silicon is easily caused when the silicon is impregnated into the molded body. As a result, the bending strength or the specific rigidity lowers. If the average grain diameter of the boron carbide grains is more than 30 μm, cracks are easily generated in the boron carbide grains and lowering of the bending strength is caused. Moreover, if the maximum grain diameter of the boron carbide grains is more than 100 μm, cracks are generated in the boron carbide grains and the bending strength lowers, and the grindability is also bad.

The grain diameter of the boron carbide powder used as a raw material and the grain diameter of the boron carbide grain in the composite material correspond approximately to each other. However, the boron carbide grain in the composite material is thought to be covered with the reacted product on the surface thereof by the reaction with the impregnated silicon, and the surface of the boron carbide grain observed by SEM is covered with a layer having a slightly different contrast. The boron carbide grain of the composite material in this invention and its grain diameter are defined including the surface layer composed of the reacted product. The reason why cracks are generated in the reaction sintering step if the fine grain of the boron carbide powder is used is presumed that the ratio of the layer composed of the reacted product in the surface thereof becomes significantly large with respect to the entirety of the boron carbide grain.

The boron carbide grain including silicon in one embodiment of the invention is defined that the characteristic X-ray of silicon is detected in the boron carbide grains when the boron carbide grains is subjected to composition analysis by EDX and the thickness of the layer(s) including silicon from the boron carbide grain surface exists in the range of 1% or more and less than 40% of the grain diameter thereof.

For obtaining the excellent grindability, it is necessary that the thickness of the layer(s) including silicon of the boron carbide grain exists in the range of 1% or more and less than 40% of the grain diameter thereof. It is preferable that the range is 5% or more and less than 40% of the grain diameter of the boron carbide grain, and further preferably, 20% or more and less than 40% of the grain diameter of the boron carbide. If the thickness of the layer including silicon is 40% or more of the grain diameter of the boron carbide, defect such as crack can be generated in the sintered body, and if less than 1%, the grinding resistance increases and the grindability becomes bad.

The preferable average grain diameter of silicon carbide powder that is a raw material for manufacturing the composite material in one embodiment of the invention is from 0.1 μm to 30 μm. Moreover, it is preferable that the maximum grain diameter of the silicon carbide powder is less than 100 μm, and further preferably less than 65 μm. However, the silicon carbide powder is different from the boron carbide powder in the point that the silicon carbide powder does not react with the silicon and crack is not generated when the silicon is impregnated into the molded body and therefore the maximum grain diameter thereof does not influence the strength more than the maximum grain diameter of the boron carbide grains.

The preferable carbon source that is a raw material for manufacturing the composite material in one embodiment of the invention is carbon powder, and it is preferable that all of the grain diameters of the reaction generated silicon carbide that is generated by reaction between the carbon and the silicon are substantially less than 10 μm.

As the carbon powder, all of carbon from that with very low crystallinity to graphite with very high crystallinity can be used. However, carbon with not so high crystallinity which is generally referred to as carbon black is easily obtainable. The preferable average grain diameter of carbon powder is from 10 nm to 1 μm.

The substantially entire amount of such carbon powder is presumed to transform into the reaction generated silicon carbide by the reaction with silicon in the reaction sintering step, and in the result of observation of the composite material, the carbon powder that was thought to be unreacted was not observed.

Moreover, as the carbon source, organic material can be used as well as the carbon powder. When organic material is used as the carbon source, it is necessary to select the organic material having a high residual carbon rate in the sintering step in a non-oxidizing atmosphere, and the particularly preferable organic material includes phenolic resin or furan resin. In the case that such organic material is used as the carbon source, the organic material can also be expected to function as a binder in the molding step or to function as a plasticity-providing agent or to function as a solvent for dispersing the powder.

The silicon that is a raw material for manufacturing the composite material in one embodiment of the invention is molten and impregnated, and therefore its form such as powder form, granular form, and plate form is not limited, it is sufficient to use the silicon having the shape that can be disposed so as to be easily impregnated into the molded body.

Moreover, silicon occasionally includes a substance except for silicon as impurities. However, the amount of the silicon in the composite material in the invention is defined as the silicon matrix including the impurities.

As the impurities in the silicon, as well as the materials included inevitably on the process of manufacturing the silicon, impurities such as B, C, Al, Ca, Mg, Cu, Ba, Sr, Sn, Ge, Pb, Ni, Co, Zn, Ag, Au, Ti, Y, Zr, V, Cr, Mn, and Mo can also be intentionally added in order to lower the melt point of the silicon to lower the temperature of the reaction sintering step or in order to prevent reaction with boron carbide on the boron carbide surface or in order to prevent blowoff of the silicon from the reaction sintered body in cooling step after the reaction sintering or in order to control thermal expansion coefficient of the silicon or in order to provide conductivity to the composite material or the like.

The method for manufacturing a composite material in one embodiment of the invention includes: a molding step of manufacturing a molded body by molding a raw material having boron carbide, the initial injected silicon carbide, and a carbon source as main components; and a reaction sintering step of impregnating silicon into the molded body to transform the carbon into silicon carbide and thereby to fill the silicon in the void thereof.

The molding method in one embodiment of the invention is not particularly limited, and dry pressing, wet pressing, CIP, slip casting, injection molding, extrusion molding, plastic molding, vibration molding, and so forth can be selected according to shape or production volume of the target work.

Among them, slip casting is suitable for manufacturing products with large sizes and complex shapes.

When slip casting is adopted as the molding method in one embodiment of the invention, an organic solvent or water may be used as the solvent. However, considering simplification of the steps or influence on the earth's environment, it is preferable that water is used as the solvent.

In the case of slip casting by using water as the solvent, a slurry in which the boron carbide powder and the initial injected silicon carbide powder and the carbon source, which are raw materials, and water are mixed is first manufactured. And in this case, additive such as dispersant or deflocculant for manufacturing the slurry with high concentration, binder, or plasticity-providing agent can also be added.

The preferable additive includes ammonium polycarboxylate, sodium polycarboxylate, sodium alginate, ammonium alginate, triethanolamine alginate, styrene-maleic acid copolymer, dibutylphthal, carboxylmethylcellulose, sodium carboxylmethylcellulose, ammonium carboxylmethylcellulose, methylcellulose, sodium methylcellulose, polyvinylalcohol, polyethylene oxide, sodium polyacrylate, oligomer of acrylic acid or its ammonium salt, various amines such as monoethylamine, pyridine, piperidine, tetramethylammonium hydroxide, dextrin, peptone, hydrosoluble starch, various resin emulsions such as acrylic emulsion, various hydrosoluble resins such as resorcinol-type phenolic resin, various non-hydrosoluble resins such as novolac-type phenolic resin, and water glass.

When the non-hydrosoluble additive is added, it is preferable that the additive is set to be an emulsion or is coated on a powder surface, and moreover, when a crushing step is included as a step of manufacturing the slurry, it is preferable that the additive that is degraded by crushing is added after the crushing step.

Moreover, in slip casting step, both of gypsum slip casting by utilizing the capillary suction pressure of gypsum mold and pressure slip casting by directly applying pressure to the slurry are available. In the case of pressure slip casting, the appropriate pressure is from 0.1 MPa to 5 MPa.

In the molding step, it is important to manufacture the molded body having a high filling ratio. This is because the silicon is filled into the void of the molded body excluding the expansion volume part by transformation from the carbon into silicon carbide by the reaction with silicon. That is, the reaction sintered body manufactured from the highly-filled molded body has small silicon content, and the reaction sintered body with small silicon content can be expected to have the high specific rigidity.

The preferable filling ratio of the molded body is 60-80% and furthermore, preferably 65-75%.

The reason why the preferable filling ratio has the lower limit is that the silicon content of the reaction sintered body is set to be small as described above. However, the reason why the preferable filling ratio has the upper limit is that silicon is difficult to be impregnated into the molded body having a too high filling ratio. However, actually, it is difficult to industrially manufacture the molded body having such a high filling ratio, and therefore, it is sufficient to consider only the lower limit.

The above filling ratio of the molded body is the filling ratio of the respective powders of the boron carbide and the silicon carbide and the carbon, and the component such as the additive vaporizing by the calcination step is excluded. Accordingly, in the case of using the additive having a residual carbon part such as phenolic resin, the residual carbon part is added as the filling ratio. For the specific measuring and recording methods, the filling ratio of the molded body measured by Archimedes' method is shown to be F3, and the filling ratio that the vaporizing part is excluded therefrom is shown to be F3′, and the preferable filling ratio of the molded body indicates the value of F3′.

Between the molding step and the reaction sintering step of the composite material in one embodiment of the invention, a calcination step can also be provided.

When the molded body has a small size and a simple shape, the calcination step is not occasionally required. However, when the molded body has a large size and a complex shape, it is preferable to provide the calcination step for preventing break of the molded body in handling and generation of cracks in the reaction sintering.

As the calcination temperature, the preferable temperature is 1000-2000°C., and if the temperature is lower than 1000° C., the effect of calcination cannot be expected and if the temperature is higher than 2000° C., sintering starts and thereby the work is contracted, and there is fear that the advantage as the near-net-shape manufacturing process which is a characteristic of the manufacturing process of the present composite material and in which the sintering contraction is almost zero is lost. Moreover, the preferable atmosphere in the calcination step is non-oxidizing atmosphere.

The calcination step is generally performed in combination with a degreasing step of the molded body. However, if contamination of the furnace is feared, the degreasing step may be separately provided before the calcination step.

Moreover, only the degreasing step may be provided without the calcination step. In this case, it is sufficient to adopt the degreasing temperature required for degradation and removal of the binder part.

The preferable reaction sintering temperature in the subsequent silicon-impregnating reaction sintering step is from the melting point of silicon to 1800° C. As the work is larger and has a more complex shape, the impregnation of silicon becomes difficult, and therefore, it is necessary to set the reaction sintering temperature to be high and to set the time holding the maximum temperature to be long. However, it is preferable that the reaction sintering temperature is low and the maximum-temperature-holding time is short as much as possible, in the range that reaction sintering in which the carbon transforms into the silicon carbide completely progresses and that the silicon is completely impregnated and thereby the void comes to disappear.

Because the melt point of silicon is 1414° C., the reaction sintering temperature of 1430° C. or more is generally required. However, if impurities are added to the silicon to lower the melt point, the reaction sintering temperature can be lowered to about 1350° C.

As described above, as to the composite material in one embodiment of the invention, the composition ratio of the reaction sintered body can be defined by the mixing ratio of the raw materials of the molded body and measurement of the filling ratio F3′ of the molded body, because the carbon in the molded body expands by the reaction with the silicon into silicon carbide, and the silicon comes to fill the void thereof.

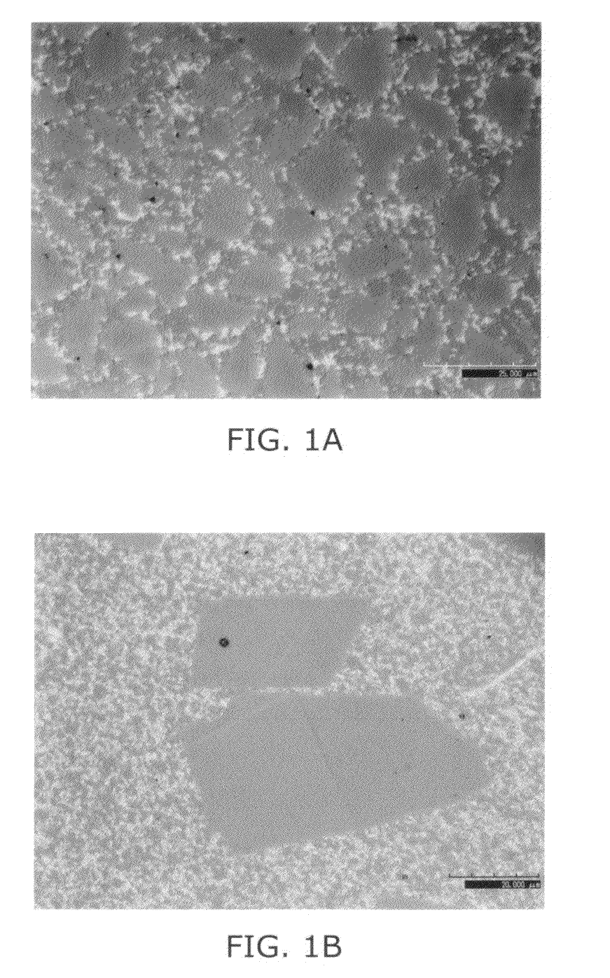

The gray parts of FIG. 1, which is a photograph of the fine structure to be described layer, are grains of boron carbide or silicon carbide, and the white parts are silicon, and therefore, the identification between the grain and the silicon is easy. Moreover, the identification between the silicon carbide and the boron carbide can be easily performed by SEM·EPMA analysis.

As described above, the composition ratio of the raw materials for realizing the composition ratio of the composite material in one embodiment of the invention can be obviously calculated from the composition ratio of the target composite material and the expected filling ratio of the molded body. However, the preferable mixing ratio of each of the raw materials is 0-50 parts by weight of the carbon source, with respect to the total 100 parts by weight of 10-90 parts by weight of boron carbide and 90-10 parts by weight of initial injected silicon carbide.

Here, the part by weight of the carbon source is the weight of the carbon when the carbon source is converted into carbon, and in the case of using the carbon powder, the mixing weight itself is used, and in the case of utilizing the additive having the residual carbon part, the value that is the mixing weight multiplied by the residual carbon ratio is used.

The problems caused when each of the components of boron carbide and silicon carbide departs from the preferable composition range of the raw materials are the same as the problems caused when each of the components of boron carbide and silicon carbide that are constituents of the above composite material departs from the preferable range.

0 part by weight of the carbon is possible, but because the reaction with the expansion by the reaction of the carbon with the silicon cannot be utilized in this case, it becomes difficult to completely fill the void of the molded body with the silicon, and it is highly possible that the void remains. If the carbon part is too large, cracks can be generated in the reaction sintered body by the expansion reaction.

Therefore, the further preferable mixing ratio of the carbon source is 10-40 parts by weight with respect to the total 100 parts by weight of the boron carbide and the initial injected silicon carbide. Moreover, the preferable silicon amount required for the reaction sintering is 105-200% of the silicon amount required for making the carbon transform into silicon carbide and further completely filling the void, and further preferably, 110-150%, and the amount is appropriately adjusted by size and shape of the molded body.

The preferable bending strength of the composite material in one embodiment of the invention is 350 MPa or more, and further preferably, 400 MPa or more.

The preferable specific rigidity of the composite material in one embodiment of the invention is 100 GPa or more, and further preferably, 130 GPa or more.

There is no preferable upper limit for the specific rigidity, but realistically, it is difficult to make the composite material having the specific rigidity of 200 GPa or more, and for achieving the high specific rigidity with holding the excellent grindability, about 170 GPa is the upper limit.

There is no preferable upper limit for the strength, but in the case of prioritizing improvement of physical properties such as the specific rigidity, it is occasionally difficult to obtain the bending strength of 1200 MPa or more.

The composite material in one embodiment of the invention is suitably applied to products requiring high strength and high specific rigidity and also requiring precise grinding or to products with large grinding cost because of large sizes and complex shapes. In particular, the preferable application example to products includes semiconductor or liquid crystal-manufacturing device members. Among them, the particular preferable application example to products includes members for exposure devices, and by using the composite material as a wafer-supporting member such as a susceptor or a stage or as an optical support member such as a reticle stage, the positioning accuracy of the exposure device can be improved, and by shortening the positioning time, the through-put of the device can be improved.

### EXAMPLE

Hereinafter, one embodiment of the invention will be described with reference to table and drawings.

In Table 1, a view of Examples and Comparative examples to be described below is shown.

Each of the reaction sintered bodies was sliced into a test piece after removing the excess silicon in the surface, and the surface thereof was polished, and then, specific gravity was measured by Archimedes' method, and Young's modulus was measured by a resonance method, and the specific rigidity was calculated. Moreover, the bending strength was measured by a three-point bending test based on JIS R1601. Test piece numbers of the specific gravity, Young's modulus, and bending strength were 5, 5, and 10, respectively.

Moreover, the reaction sintered body subjected to surface treatment was disposed on a dynamometer (manufactured by Kistler Co., Ltd., Model Number 9256C2), and a hole with a depth of 4 mm was processed by a core drill with (φ 10 mm (#60, manufactured by Asahi Diamond Industrial Co., Ltd. ) at a frequency of 100 m/min (3200 rpm) at a feed speed of 2 mm/min at a step amount of 0.2 mm, and the processing resistance was measured and the chipping state around the hole was confirmed. For the evaluation of machinability, the case that the maximum value of the processing resistance is 2000 N or more is X, and the case of 1500-2000 N is Δ, the case of less than 1500 N is O. Thereby, the evaluation was performed.

However, even when the maximum resistance is Δor X, in the case that the processing resistance lowers in a short time to be stable at the low value, the evaluation was performed at the low value. Moreover, even when the processing resistance is O or Δ, the case that cracks presumed to be due to processing are generated in processing and the case that tool break is caused are X.

For the evaluation of state of chipping, the case that chip of the periphery of the hole is less than 0.3 mm is O, and the case of 0.3 mm or more and less than 0.5 mm is Δ, and the case of 0.5 mm or more is X. Moreover, for the observation of the fine structure, the sintered body was sliced into appropriate sizes, and a surface thereof was lapped by an abrasive grain of 1 μm, and observed by an optical microscope with setting it to x2800 magnification.

In FIG. 1A, an optical microscopic image of the reaction sintered body fine structure of Example 1 is shown, and in FIG. 1B, that of Comparative example 1 is shown. As described above, the identification between the grain of 10 μm or more and the grain of 10 μm or less was easy. Moreover, it can be confirmed that cracks are generated in the boron carbide grain of Comparative example 1. This causes lowering of the strength.

In each of Example and Comparative example, grain diameters of 200 or more boron carbide grains were measured from 20 or more electron microscopic images, the average grain diameter and the maximum grain diameter were obtained. In the images measured in Example, a boron carbide grain having a grain diameter of more than 100 μm was not observed.

In FIG. 2, the result of linearly analyzing the boron carbide grain by EDX (energy dispersive X-ray fluorescence analyzer) is shown. It can be confirmed that silicon is included from the surface of a boron carbide grain having a grain diameter of about 11 μm to a depth of about 2.5 μm thereof.

### Example 1

30 parts by weight of silicon carbide powder having an average grain diameter of 0.6 μm, 70 parts by weight of boron carbide powder having an average grain diameter of 13 μm, and 15 parts by weight of carbon black powder having an average grain diameter of 55 nm were injected and dispersed in pure water to which a dispersant of 0.1-1 part by weight with respect to the silicon carbide powder, the boron carbide powder, and the carbon black powder was added, and pH was adjusted to 8-9.5 by ammonia water or the like, and thereby, the slurry having a low viscosity of less than 500 CP was produced. The slurry was mixed for some hours in a pot mill or the like, and then, a binder of 1-2 parts by weight with respect to the silicon carbide powder, the boron carbide powder, and the carbon black powder was added thereto and mixed, and then, the slurry was defoamed, and an acrylic pipe having an inner diameter of 80 mm is put on a gypsum plate, and the slurry was cast, and thereby, the molded body having a thickness of approximately 10 mm was produced. The molded body was naturally dried and then dried at 100-150° C. and then held for 2 hours at a temperature of 600° C. under reduced pressure of 1×10⁻⁴−1×10⁻³ torr and degreased, and then held for 1 hour at 1700° C. and thereby calcined. After calcination, the temperature was heated to 1470° C. and held for 30 min, and molten silicon was impregnated into the molded body, and thereby, the reaction sintered body was manufactured.

### Examples 2-3

30 parts by weight of silicon carbide powder having an average grain diameter of 0.6 μm, 70 parts by weight of boron carbide powder having an average grain diameter of 13 μm, and 15 or 20 parts by weight of carbon black powder having an average grain diameter of 55 nm were injected and dispersed in pure water to which a dispersant of 0.1-1 part by weight with respect to the silicon carbide powder, the boron carbide powder, and the carbon black powder was added, and pH was adjusted to 8-9.5 by ammonia water or the like, and thereby, the slurry having a low viscosity of less than 500 CP was produced. The slurry was mixed for some hours in a pot mill or the like, and then, a binder of 1-2 parts by weight with respect to the silicon carbide powder, the boron carbide powder, and the carbon black powder was added thereto and mixed, and then, the slurry was defoamed, and an acrylic pipe having an inner diameter of 80 mm is put on a gypsum plate, and the slurry was cast, and thereby, the molded body having a thickness of approximately 10 mm was produced. The molded body was naturally dried and then dried at 100-150° C. and then held for 2 hours at a temperature of 600° C. under reduced pressure of 1×10⁻⁴−1×10⁻³ torr and degreased, and then held for 1 hour at 1700° C. and thereby calcined. After calcination, the temperature was heated to 1470° C. and held for 30 min, and molten silicon was impregnated into the molded body, and thereby, the reaction sintered body was manufactured. Examples 2 and 3 are the cases that the addition amounts of the carbon black powders are 20, 15 parts by weight, respectively.

### Examples 4-5

30 parts by weight of silicon carbide powder having an average grain diameter of 0.6 μm, 70 parts by weight of boron carbide powder having an average grain diameter of 23 μm, and 15 or 20 parts by weight of carbon black powder having an average grain diameter of 55 nm were injected and dispersed in pure water to which a dispersant of 0.1-1 part by weight with respect to the silicon carbide powder, the boron carbide powder, and the carbon black powder was added, and pH was adjusted to 8-9.5 by ammonia water or the like, and thereby, the slurry having a low viscosity of less than 500 CP was produced. The slurry was mixed for some hours in a pot mill or the like, and then, a binder of 1-2 parts by weight with respect to the silicon carbide powder, the boron carbide powder, and the carbon black powder was added thereto and mixed, and then, the slurry was defoamed, and an acrylic pipe having an inner diameter of 80 mm is put on a gypsum plate, and the slurry was cast, and thereby, the molded body having a thickness of approximately 10 mm was produced. The molded body was naturally dried and then dried at 100-150° C. and then held for 2 hours at a temperature of 600° C. under reduced pressure of 1×10⁻⁴−1×10⁻³ torr and degreased, and then held for 1 hour at 1700° C. and thereby calcined. After calcination, the temperature was heated to 1470° C. and held for 30 min, and molten silicon was impregnated into the molded body, and thereby, the reaction sintered body was manufactured. Examples 4 and 5 are the cases that the addition amounts of the carbon black powders are 20, 15 parts by weight, respectively.

### Example 6

30 parts by weight of silicon carbide powder having an average grain diameter of 0.6 μm, 70 parts by weight of boron carbide powder having an average grain diameter of 23 μm, and 20 parts by weight of carbon black powder having an average grain diameter of 55 nm were injected and dispersed in pure water to which a dispersant of 0.1-1 part by weight with respect to the silicon carbide powder, the boron carbide powder, and the carbon black powder was added, and pH was adjusted to 8-9.5 by ammonia water or the like, and thereby, the slurry having a low viscosity of less than 500 CP was produced. The slurry was mixed for some hours in a pot mill or the like, and then, a binder of 1-2 parts by weight with respect to the silicon carbide powder, the boron carbide powder, and the carbon black powder was added thereto and mixed, and then, the slurry was defoamed, and an acrylic pipe having an inner diameter of 80 mm is put on a gypsum plate, and the slurry was cast, and thereby, the molded body having a thickness of approximately 10 mm was produced. The molded body was naturally dried and then dried at 100-150° C. and then held for 2 hours at a temperature of 600° C. under reduced pressure of 1×10⁻⁴−1×10⁻³ torr and degreased, and then held for 1 hour at 1700° C. and thereby calcined. After calcination, the temperature was heated to 1470° C. and held for 30 min, and molten silicon was impregnated into the molded body, and thereby, the reaction sintered body was manufactured.

### Example 7

30 parts by weight of silicon carbide powder having an average grain diameter of 0.6 μm, 70 parts by weight of boron carbide powder having an average grain diameter of 28 μm, and 20 parts by weight of carbon black powder having an average grain diameter of 55 nm were injected and dispersed in pure water to which a dispersant of 0.1-1 part by weight with respect to the silicon carbide powder, the boron carbide powder, and the carbon black powder was added, and pH was adjusted to 8-9.5 by ammonia water or the like, and thereby, the slurry having a low viscosity of less than 500 CP was produced. The slurry was mixed for some hours in a pot mill or the like, and then, a binder of 1-2 parts by weight with respect to the silicon carbide powder, the boron carbide powder, and the carbon black powder was added thereto and mixed, and then, the slurry was defoamed, and an acrylic pipe having an inner diameter of 80 mm is put on a gypsum plate, and the slurry was cast, and thereby, the molded body having a thickness of approximately 10 mm was produced. The molded body was naturally dried and then dried at 100-150° C. and then held for 2 hours at a temperature of 600° C. under reduced pressure of 1×10⁻⁴−1×10⁻³ torr and degreased, and then held for 1 hour at 1700° C. and thereby calcined. After calcination, the temperature was heated to 1470° C. and held for 30 min, and molten silicon was impregnated into the molded body, and thereby, the reaction sintered body was manufactured.

### Comparative Example 1

30 parts by weight of silicon carbide powder having an average grain diameter of 0.6 μm, 70 parts by weight of boron carbide powder having an average grain diameter of 50 μm, and 20 parts by weight of carbon black powder having an average grain diameter of 55 nm were injected and dispersed in pure water to which a dispersant of 0.1-1 part by weight with respect to the silicon carbide powder, the boron carbide powder, and the carbon black powder was added, and pH was adjusted to 8-9.5 by ammonia water or the like, and thereby, the slurry having a low viscosity of less than 500 CP was produced. The slurry was mixed for some hours in a pot mill or the like, and then, a binder of 1-2 parts by weight with respect to the silicon carbide powder, the boron carbide powder, and the carbon black powder was added thereto and mixed, and then, the slurry was defoamed, and an acrylic pipe having an inner diameter of 80 mm is put on a gypsum plate, and the slurry was cast, and thereby, the molded body having a thickness of approximately 10 mm was produced. The molded body was naturally dried and then dried at 100-150° C. and then held for 2 hours at a temperature of 600° C. under reduced pressure of 1×10⁻⁴−1×10⁻³ torr and degreased, and then held for 1 hour at 1700° C. and thereby calcined. After calcination, the temperature was heated to 1470° C. and held for 30 min, and molten silicon was impregnated into the molded body, and thereby, the reaction sintered body was manufactured.

### Comparative Example 2

20 parts by weight of silicon carbide powder having an average grain diameter of 0.6 μm, 30 parts by weight of silicon carbide powder having an average grain diameter of 65 μm, 50 parts by weight of boron carbide powder having an average grain diameter of 50 μm, and 30 parts by weight of carbon black powder having an average grain diameter of 55 nm were injected and dispersed in pure water to which a dispersant of 0.1-1 part by weight with respect to the silicon carbide powder, the boron carbide powder, and the carbon black powder was added, and pH was adjusted to 8-9.5 by ammonia water or the like, and thereby, the slurry having a low viscosity of less than 500 cp was produced. The slurry was mixed for some hours in a pot mill or the like, and then, a binder of 1-2 parts by weight with respect to the silicon carbide powder, the boron carbide powder, and the carbon black powder was added thereto and mixed, and then, the slurry was defoamed, and an acrylic pipe having an inner diameter of 80 mm is put on a gypsum plate, and the slurry was cast, and thereby, the molded body having a thickness of approximately 10 mm was produced. The molded body was naturally dried and then dried at 100-150° C. and then held for 2 hours at a temperature of 600° C. under reduced pressure of 1×10⁻⁴−1×10⁻³ torr and degreased, and then held for 1 hour at 1700° C. and thereby calcined. After calcination, the temperature was heated to 1470° C. and held for 30 min, and molten silicon was impregnated into the molded body, and thereby, the reaction sintered body was manufactured.

### Comparative Example 3

25 parts by weight of silicon carbide powder having an average grain diameter of 0.6 μm, 25 parts by weight of silicon carbide powder having an average grain diameter of 65 μm, 20 parts by weight of boron carbide powder having an average grain diameter of 50 μm, and 10 parts by weight of carbon black powder having an average grain diameter of 55 nm were injected and dispersed in pure water to which a dispersant of 0.1-1 part by weight with respect to the silicon carbide powder, the boron carbide powder, and the carbon black powder was added, and pH was adjusted to 8-9.5 by ammonia water or the like, and thereby, the slurry having a low viscosity of less than 500 cp was produced. The slurry was mixed for some hours in a pot mill or the like, and then, a binder of 1-2 parts by weight with respect to the silicon carbide powder, the boron carbide powder, and the carbon black powder was added thereto and mixed, and then, the slurry was defoamed, and an acrylic pipe having an inner diameter of 80 mm is put on a gypsum plate, and the slurry was cast, and thereby, the molded body having a thickness of approximately 10 mm was produced. The molded body was naturally dried and then dried at 100-150° C. and then held for 2 hours at a temperature of 600° C. under reduced pressure of 1×10⁻⁴−1×10⁻³ torr and degreased, and then held for 1 hour at 1700° C. and thereby calcined. After calcination, the temperature was heated to 1470° C. and held for 30 min, and molten silicon was impregnated into the molded body, and thereby, the reaction sintered body was manufactured.

### Comparative Example 4

25 parts by weight of silicon carbide powder having an average grain diameter of 0.6 μm, 25 parts by weight of silicon carbide powder having an average grain diameter of 65 μm, 50 parts by weight of boron carbide powder having an average grain diameter of 50 μm, and 20 parts by weight of carbon black powder having an average grain diameter of 55 nm were injected and dispersed in pure water to which a dispersant of 0.1-1 part by weight with respect to the silicon carbide powder, the boron carbide powder, and the carbon black powder was added, and pH was adjusted to 8-9.5 by ammonia water or the like, and thereby, the slurry having a low viscosity of less than 500 cp was produced. The slurry was mixed for some hours in a pot mill or the like, and then, a binder of 1-2 parts by weight with respect to the silicon carbide powder, the boron carbide powder, and the carbon black powder was added thereto and mixed, and then, the slurry was defoamed, and an acrylic pipe having an inner diameter of 80 mm is put on a gypsum plate, and the slurry was cast, and thereby, the molded body having a thickness of approximately 10 mm was produced. The molded body was naturally dried and then dried at 100-150° C. and then held for 2 hours at a temperature of 600° C. under reduced pressure of 1×10⁻⁴−1×10⁻³ torr and degreased, and then held for 1 hour at 1700° C. and thereby calcined. After calcination, the temperature was heated to 1470° C. and held for 30 min, and molten silicon was impregnated into the molded body, and thereby, the reaction sintered body was manufactured.

### Comparative Example 5

30 parts by weight of silicon carbide powder having an average grain diameter of 0.6 μm, 70 parts by weight of boron carbide powder having an average grain diameter of 34 μm, and 20 parts by weight of carbon black powder having an average grain diameter of 55 nm were injected and dispersed in pure water to which a dispersant of 0.1-1 part by weight with respect to the silicon carbide powder, the boron carbide powder, and the carbon black powder was added, and pH was adjusted to 8-9.5 by ammonia water or the like, and thereby, the slurry having a low viscosity of less than 500 cp was produced. The slurry was mixed for some hours in a pot mill or the like, and then, a binder of 1-2 parts by weight with respect to the silicon carbide powder, the boron carbide powder, and the carbon black powder was added thereto and mixed, and then, the slurry was defoamed, and an acrylic pipe having an inner diameter of 80 mm is put on a gypsum plate, and the slurry was cast, and thereby, the molded body having a thickness of approximately 10 mm was produced. The molded body was naturally dried and then dried at 100-150° C. and then held for 2 hours at a temperature of 600° C. under reduced pressure of 1×10⁻⁴−1×10⁻³ torr and degreased, and then held for 1 hour at 1700° C. and thereby calcined. After calcination, the temperature was heated to 1470° C. and held for 30 min, and molten silicon was impregnated into the molded body, and thereby, the reaction sintered body was manufactured.

### Comparative Example 6

80 parts by weight of silicon carbide powder having an average grain diameter of 0.6 μm, 20 parts by weight of boron carbide powder having an average grain diameter of 4 μm, and 50 parts by weight of carbon black powder having an average grain diameter of 55 nm were injected and dispersed in pure water to which a dispersant of 0.1-1 part by weight with respect to the silicon carbide powder, the boron carbide powder, and the carbon black powder was added, and pH was adjusted to 8-9.5 by ammonia water or the like, and thereby, the slurry having a low viscosity of less than 500 cp was produced. The slurry was mixed for some hours in a pot mill or the like, and then, a binder of 1-2 parts by weight with respect to the silicon carbide powder, the boron carbide powder, and the carbon black powder was added thereto and mixed, and then, the slurry was defoamed, and an acrylic pipe having an inner diameter of 80 mm is put on a gypsum plate, and the slurry was cast, and thereby, the molded body having a thickness of approximately 10 mm was produced. The molded body was naturally dried and then dried at 100-150° C. and then held for 2 hours at a temperature of 600° C. under reduced pressure of 1×10⁻⁴−1×10⁻³ torr and degreased, and then held for 1 hour at 1700° C. and thereby calcined. After calcination, the temperature was heated to 1470° C. and held for 30 min, and molten silicon was impregnated into the molded body, and thereby, the reaction sintered body was manufactured.

In Examples 1-7, the bending strength was 350 MPa or more and the specific rigidity was 130 GPa or more, and the grinding resistance was small and chipping was difficult to be caused, and therefore, the composite material excellent in grinding workability could be manufactured.

In Comparative examples 1-5, the specific rigidity was 130 GPa or more, but the bending strength was less than 350 MPa. In Comparative examples 2-5, the grinding resistance was large.

In Comparative example 6, fine cracks were generated in the composite material, and the bending strength and the specific rigidity lowered, and therewith, chipping was easily caused in grinding.

Moreover, in each of the reaction sintered bodies, its surface was lapped and linear analysis of the boron carbide grains was performed by EDX, and the thickness of the layer including silicon (hereinafter, silicon-including layer) was measured. Test piece number thereof was 5. The evaluation was performed so that the case the thickness of the silicon-including layer is 20% or more and less than 40% with respect to the grain diameter of the boron carbide is A and so that the case of 5% or more and less than 20% is B and so that the case of 1% or more and less than 5% is C and so that the case of less than 1% is D and so that the case of 40% or more is E.

The result was that Examples 1 and 2 were A and Examples 3, 4, 5, and 6 were B and Example 7 was C and Comparative example 1, 2, 3, 4, and 5 were D and Comparative example 6 was E.

TABLE 1

| | | | BORON CARBIDE | | | | |
|---|---|---|---|---|---|---|---|
| | | | AVERAGE | MAXIMUM | | | |
| | | SILICON | GRAIN | GRAIN | | CHARACTERISTICS | |
| | SILICON | CARBIDE | DIAMETER | DIAMETER | | OF MOLDED BODY | |
| | [vol %] | [vo %] | [μm] | [μm] | [vol %] | F3 | F3′ |
| EXAMPLE 1 | 14.3 | 43.5 | 13 | 40 | 42.2 | 0.74 | 0.71 |
| EXAMPLE 2 | 13.1 | 48.9 | 13 | 37 | 38.0 | 0.72 | 0.70 |
| EXAMPLE 3 | 15.1 | 46.5 | 13 | 34 | 38.4 | 0.71 | 0.69 |
| EXAMPLE 4 | 16.9 | 45.1 | 23 | 61 | 38.0 | 0.74 | 0.71 |
| EXAMPLE 5 | 15.1 | 42.2 | 23 | 61 | 42.7 | 0.74 | 0.71 |
| EXAMPLE 6 | 17.6 | 42.9 | 25 | 63 | 39.5 | 0.73 | 0.70 |
| EXAMPLE 7 | 16.9 | 43.1 | 28 | 90 | 40.0 | 0.74 | 0.71 |
| COMPARATIVE | 20.3 | 46.9 | 50 | 103 | 32.9 | 0.71 | 0.67 |
| EXAMPLE 1 | | | | | | | |
| COMPARATIVE | 12.3 | 62.6 | 50 | 116 | 25.1 | 0.72 | 0.68 |
| EXAMPLE 2 | | | | | | | |
| COMPARATIVE | 19.0 | 46.5 | 50 | 109 | 34.6 | 0.77 | 0.73 |
| EXAMPLE 3 | | | | | | | |
| COMPARATIVE | 15.1 | 55.8 | 50 | 113 | 29.1 | 0.74 | 0.70 |
| EXAMPLE 4 | | | | | | | |
| COMPARATIVE | 16.1 | 43.9 | 34 | 83 | 40.0 | 0.74 | 0.71 |
| EXAMPLE 5 | | | | | | | |
| COMPARATIVE | 25.8 | 67.3 | 4 | 12 | 6.8 | 0.56 | 0.53 |
| EXAMPLE 6 | | | | | | | |

PHYSICAL PROPERTY VALUE

| | | YOUNG'S | | BENDING | WORKABILITY | |
|---|---|---|---|---|---|---|
| | SPECIFIC | MODULUS | SPECIFIC | STRENGTH | MACHIN- | |
| | GRAVITY | [GPa] | RIGIDITY | [MPa] | ABILITY | CHIPPING |
| EXAMPLE 1 | 2.78 | 390 | 140 | 528 | ∘ | ∘ |
| EXAMPLE 2 | 2.82 | 392 | 139 | 496 | ∘ | ∘ |
| EXAMPLE 3 | 2.80 | 395 | 141 | 568 | ∘ | ∘ |
| EXAMPLE 4 | 2.78 | 394 | 142 | 435 | ∘ | ∘ |
| EXAMPLE 5 | 2.77 | 389 | 140 | 448 | ∘ | ∘ |
| EXAMPLE 6 | 2.77 | 392 | 142 | 413 | ∘ | ∘ |
| EXAMPLE 7 | 2.77 | 386 | 139 | 355 | ∘ | ∘ |
| COMPARATIVE | 2.84 | 400 | 141 | 344 | Δ | ∘ |
| EXAMPLE 1 | | | | | | |
| COMPARATIVE | 2.91 | 395 | 136 | 311 | Δ | Δ |
| EXAMPLE 2 | | | | | | |
| COMPARATIVE | 2.81 | 393 | 140 | 323 | Δ | ∘ |
| EXAMPLE 3 | | | | | | |
| COMPARATIVE | 2.86 | 400 | 140 | 330 | Δ | ∘ |
| EXAMPLE 4 | | | | | | |
| COMPARATIVE | 2.78 | 388 | 140 | 346 | Δ | ∘ |
| EXAMPLE 5 | | | | | | |
| COMPARATIVE | 3.00 | 347 | 116 | 236 | Δ | x |
| EXAMPLE 6 | | | | | | |

1. A composite material comprising boron carbide, silicon carbide, and silicon as main components,
an average grain diameter of boron carbide grains of the composite material being 10 μm or more and 30 μm or less.

2. The composite material according to claim 1, wherein the maximum grain diameter of the boron carbide grains is less than 100 μm.

3. The composite material according to claim 2, wherein the maximum grain diameter of the boron carbide grains is less than 65 μm.

4. The composite material according to claim 1, wherein an average of three-point bending strength of the composite material is 350 MPa or more.

5. A composite material comprising boron carbide, silicon carbide, and silicon as main components,
silicon being included in grains of the boron carbide.
